(19) United States
(12) Patent Application Publication
(10) Pub. No.: US 2025/0303762 A1
(43) Pub. Date: Oct. 2, 2025

(54) PRINTER

(71) Applicant: Toshiba Tec Kabushiki Kaisha, Tokyo (JP)

(72) Inventor: Tsuyoshi SANADA, Susono Shizuoka (JP)

(21) Appl. No.: 19/046,404

(22) Filed: Feb. 5, 2025

(30) Foreign Application Priority Data
Mar. 26, 2024 (JP) 2024-050290

(51) Int. Cl. B41J 15/16; B41J 2/32; B41J 11/04; B41J 15/04; B41J 29/13

(52) U.S. Cl. CPC B41J 15/165; B41J 2/32; B41J 11/04; B41J 15/044; B41J 29/13

(57) ABSTRACT

A printer includes a storage unit in which a roll-shaped printing medium is stored, a print head configured to print on the medium, a first roller that is rotatable to draw out the medium from the storage unit while pressing the medium against the print head, a damper disposed between the storage unit and the print head and against which the medium is pressed as a result of tension in the medium that is drawn out from the storage unit, and an elastic body including one or more non-linear elastic members against which the damper is pressed when the medium is pressed against the damper.

### CROSS-REFERENCE TO RELATED APPLICATION(S)

This application is based upon and claims the benefit of priority from Japanese Patent Application No. 2024-050290, filed Mar. 26, 2024, the entire contents of which are incorporated herein by reference.

### FIELD

Embodiments described herein relate generally to a printer.

### BACKGROUND

A printer that pulls out a portion of a sheet that is wound and stored in a roll shape and performs printing on the pulled-out portion is known.

For example, in a thermal printer, a rolled sheet is drawn out by a conveying roller such as a platen roller, and printing is performed by a thermal head arranged to face the platen roller. Further, in such a thermal printer, there has been proposed a configuration in which an elastic member applies an urging force to the thermal head in the direction towards the platen roller.

Incidentally, in the above-described printer, tension is applied to the sheet when the sheet is conveyed. Further, the tension applied to the sheet varies depending on the acceleration of sheet conveyance and the state of the rolled sheet. For example, since the diameter and weight of the rolled sheet become smaller as the sheet is pulled out, the moment of inertia of the rolled sheet fluctuates. Therefore, even when the sheet is pulled out with the same force, the tension applied to the sheet fluctuates depending on the state of the rolled sheet.

In addition, depending on the tension applied to the sheet, there is a possibility that stable sheet conveyance is hindered. For example, in a case where the tension is too large, there is a possibility that the motor that drives the platen roller gets out of synchronism and the like, which leads to deterioration in print quality. For this reason, it is preferable to reduce the applied tension and stabilize the sheet conveyance, but as described above, since the tension applied to the sheet fluctuates, a technique capable of coping with the tension fluctuation is desired.

### SUMMARY OF THE INVENTION

Embodiments of the present disclosure provide a printer capable of suitably reducing a tension fluctuation applied to a sheet.

A printer according to an embodiment includes a storage unit in which a roll-shaped printing medium is stored, a print head configured to print on the medium, a first roller that is rotatable to draw out the medium from the storage unit while pressing the medium against the print head, a damper disposed between the storage unit and the print head and against which the medium is pressed as a result of tension in the medium that is drawn out from the storage unit, and an elastic body including one or more non-linear elastic members against which the damper is pressed when the medium is pressed against the damper.

### BRIEF DESCRIPTION OF THE DRAWINGS

FIG. 1 is a perspective view illustrating an external appearance of a printer according to an embodiment.

FIG. 2 is a cross-sectional view illustrating an internal structure of a printer according to an embodiment.

FIG. 3 is a perspective view illustrating a configuration of a damper unit according to an embodiment.

FIG. 4 is a perspective view illustrating an example of a configuration of a damper unit according to an embodiment.

FIG. 5 is a perspective view illustrating an example of a configuration of a damper unit according to an embodiment.

FIG. 6 is a perspective view illustrating another example of an arrangement position of an elastic member according to an embodiment.

FIG. 7 is a perspective view illustrating an example of a spring constant of an elastic member according to an embodiment.

FIG. 8 is a diagram for explaining an operation example of a damper unit according to an embodiment.

### DETAILED DESCRIPTION

Hereinafter, embodiments will be described in detail with reference to the drawings. The present invention is not limited to the embodiments described below.

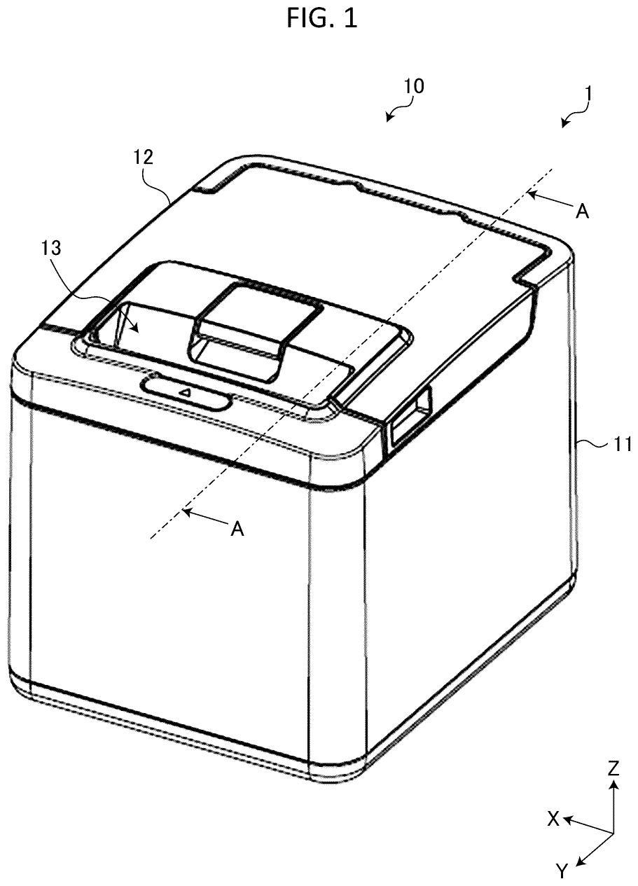

FIG. 1 is a perspective view illustrating an external appearance of a printer 1 according to an embodiment. For example, the printer 1 is a thermal printer.

In the drawings described below, for convenience, X-axis, Y-axis, and Z-axis orthogonal to each other are illustrated, and the left-right direction (i.e., X direction), the front-rear direction (i.e., Y direction), and the up-down direction (i.e., Z direction) will be described using the X-axis, the Y-axis, and the Z-axis. In the following description, when simply referred to as the X direction, the Y direction, or the Z direction, it is the respective axial directions, and includes two directions in opposite directions. In addition, when the positive direction of the X-axis is specified, the direction is one direction from the right side to the left side, when the positive direction of the Y-axis is specified, the direction is one direction from the rear side to the front side, and when the positive direction of the Z-axis is specified, the direction is one direction from the lower side to the upper side.

The printer 1 includes a lower housing 11, an upper cover 12, and a discharge port 13. The lower housing 11 is a box-shaped container having an opening on the upper side and a storage unit 18 for a rolled sheet. The lower housing 11 is provided with a connection terminal (not shown) used for connection with an external device such as a host computer that controls the printer 1, a power supply terminal (not shown) for supplying power to the printer 1, and the like. The upper cover 12 is a lid opens and closes the opening of the lower housing 11. The upper cover 12 is rotatably supported at one end by the lower housing 11, and opens and closes the opening of the lower housing 11 in accordance with the rotation.

The discharge port 13 is a gap-shaped opening through which a sheet is discharged, and the opening is formed between the other end of the upper cover 12 and the lower housing 11. The lower housing 11 and the upper cover 12 constitute a housing 10.

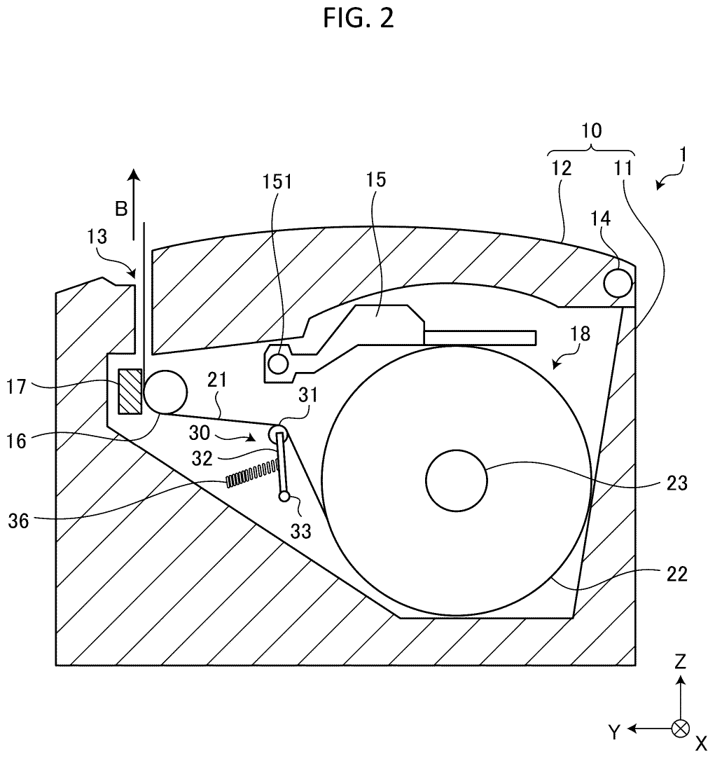

Next, the internal structure of the printer 1 will be described with reference to FIG. 2. FIG. 2 is a cross-sectional view illustrating an example of an internal structure of the printer 1. FIG. 2 is a YZ cross-sectional view of the printer 1 shown in FIG. 1 taken along the A-A line.

As shown in FIG. 2, the printer 1 stored a rolled sheet 22 formed by winding a thermal sheet 21 around a roll core 23 in a roll shape, in the storage unit 18 inside the housing 10, and performs printing while pulling out the thermal sheet 21 from the rolled sheet 22.

The sheet is not limited to the thermal sheet 21, and may be, for example, a label sheet. The label sheet may be a strip-shaped label having a predetermined size and attached to a strip-shaped base sheet, or may be a strip-shaped label having no base sheet.

The printer 1 includes a flapper 15, a platen roller 16, a thermal head 17, the storage unit 18, and a damper unit 30 inside the housing 10.

The printer 1 draws the thermal sheet 21 by the rotation of the platen roller 16, and prints on the drawn thermal sheet 21 by the thermal head 17.

The flapper 15 is provided on the rear side of the upper cover 12. The flapper 15 is rotatably attached to the upper cover 12 at an end portion on the side close to the thermal head 17. Specifically, the flapper 15 is mounted so as to be rotatable around a flapper rotation shaft 151 in a state of being biased in the direction of the rolled sheet 22 accommodated in the storage unit 18.

The flapper rotation shaft 151 is installed along the X-axis at a position on the positive side in the Y-axis direction with respect to an upper cover rotation shaft 14 that openably and closably rotates the upper cover 12. For example, a torsion spring (not shown) is attached to the flapper rotation shaft 151, and the flapper 15 is biased by the torsion spring in the direction of the rolled sheet 22 accommodated in the storage unit 18. As a result, the flapper 15 presses the rolled sheet 22 accommodated in the storage unit 18 in a direction away from the upper cover 12 side and presses the rolled sheet against the inner wall of the storage unit 18.

The platen roller 16 is installed on the rear surface side of the upper cover 12. The platen roller 16 is rotated by a driving force generated by a stepping motor (not shown), pulls out the thermal sheet 21 from the rolled sheet 22 stored in the storage unit 18, and conveys it toward the thermal head 17.

The thermal head 17 is installed on the inner surface of the lower housing 11. The thermal head 17 comes into contact with the platen roller 16 in a state where the upper cover 12 is closed. The thermal head 17 performs printing on the thermal sheet 21 conveyed by the platen roller 16. The thermal sheet 21 is conveyed toward the discharge port 13 in a state of being sandwiched between the thermal head 17 and the platen roller 16. Hereinafter, the direction of the thermal sheet 21 conveyed from the rolled sheet 22 toward the discharge port 13 is also referred to as a conveyance direction B.

The thermal head 17 has a structure in which a plurality of heating elements are aligned, and performs printing on the thermal sheet 21 sandwiched between the thermal head 17 and the platen roller 16 by causing the heating elements corresponding to the printing pattern to generate heat.

The storage unit 18 is a space for storing the rolled sheet 22 provided in the housing 10. The storage unit 18 stores the rolled sheet 22 housing into the housing 10. Here, an example is shown in which a so-called throwing method in which the roll core 23 of the rolled sheet 22 is not pivotally supported is employed in the storage unit 18, but the present invention is not limited to this configuration. For example, a configuration may be adopted in which the roll core 23 of the rolled sheet 22 is rotatably supported by providing a bearing or the like in the storage unit 18. In this case, the flapper 15 and the flapper rotation shaft 151 may not be necessary.

The damper unit 30 is provided between the platen roller 16 and the storage unit 18 or the rolled sheet 22. The damper unit 30 generates an elastic force from one surface side of the thermal sheet 21 (i.e., the lower surface side in FIG. 2), thereby reducing the tension applied to the thermal sheet 21 by pulling out by the platen roller 16.

The damper unit 30 includes a rotation roller 31, a frame unit 32, and one or more elastic members 36. The rotation roller 31 is provided at a leading end portion of the frame unit 32 and is rotatable in the conveying direction of the thermal sheet 21. The rotation roller 31 is in contact with one surface side of the thermal sheet 21 conveyed by the platen roller 16 (i.e., the lower surface side in FIG. 2), and the thermal sheet 21 is conveyed toward the thermal head 17 while being in contact with the rotation roller 31.

The frame unit 32 is a plate-shaped member provided over the width direction (i.e., X-axis direction) of the thermal sheet 21. The frame unit 32 rotatably supports the rotation roller 31 at an upper end portion thereof. Further, the frame unit 32 is rotatably supported around the axis of the frame rotation shaft 33 provided at the lower end portion.

The elastic member 36 is provided on the Y-axis positive direction side of the frame unit 32. The elastic member 36 biases the frame unit 32 toward the Y-axis negative direction side to rotate around the frame rotation shaft 33.

Specifically, the frame unit 32 is rotated in a direction approaching the thermal sheet 21 by the bias of the elastic member 36. As a result, the thermal sheet 21 drawn out from the rolled sheet 22 is pressed by the rotation roller 31 attached to the front end of the frame unit 32 to form a buffer region that is bent upward in the drawing.

Further, when tension is applied to the thermal sheet 21 by the conveyance of the thermal sheet 21 by the platen roller 16, the rotation roller 31 attached to the front end of the frame unit 32 is pressed downward by the thermal sheet 21, and the frame unit 32 is rotated in a direction away from the rolled sheet 22.

As described above, the damper unit 30 forms a buffer region between the platen roller 16 and the rolled sheet 22, and reduces the tension applied to the thermal sheet 21. In addition, the damper unit 30 reduces the power at the time of starting the conveyance of the thermal sheet 21 by the platen roller 16 or the like from directly reaching the rolled sheet 22.

Incidentally, the tension applied to the thermal sheet 21 varies depending on the acceleration of sheet conveyance and the state of the rolled sheet 22. For example, since the diameter and weight of the rolled sheet 22 become smaller as the thermal sheet 21 is drawn out, the moment of inertia of the rolled sheet 22 fluctuates. Therefore, even when the thermal sheet 21 is pulled out with the same force, the tension applied to the thermal sheet 21 fluctuates depending on the state of the rolled sheet 22.

However, when the tension applied to the thermal sheet 21 fluctuates, if the elastic modulus (for example, the spring constant) of the elastic member 36 is single, it may not be possible to appropriately cope with a change in the state of the rolled sheet 22. For example, if it is not possible to cope with a situation in which the tension becomes large, such as immediately after the replacement of the rolled sheet 22, or a situation in which the tension becomes small, such as near the replacement, the motor that drives the platen roller 16 gets out of synchronism, which may lead to deterioration in print quality.

Therefore, the damper unit 30 is provided with a configuration for dealing with a variation in tension applied to the thermal sheet 21. Hereinafter, a detailed configuration of the damper unit 30 will be described.

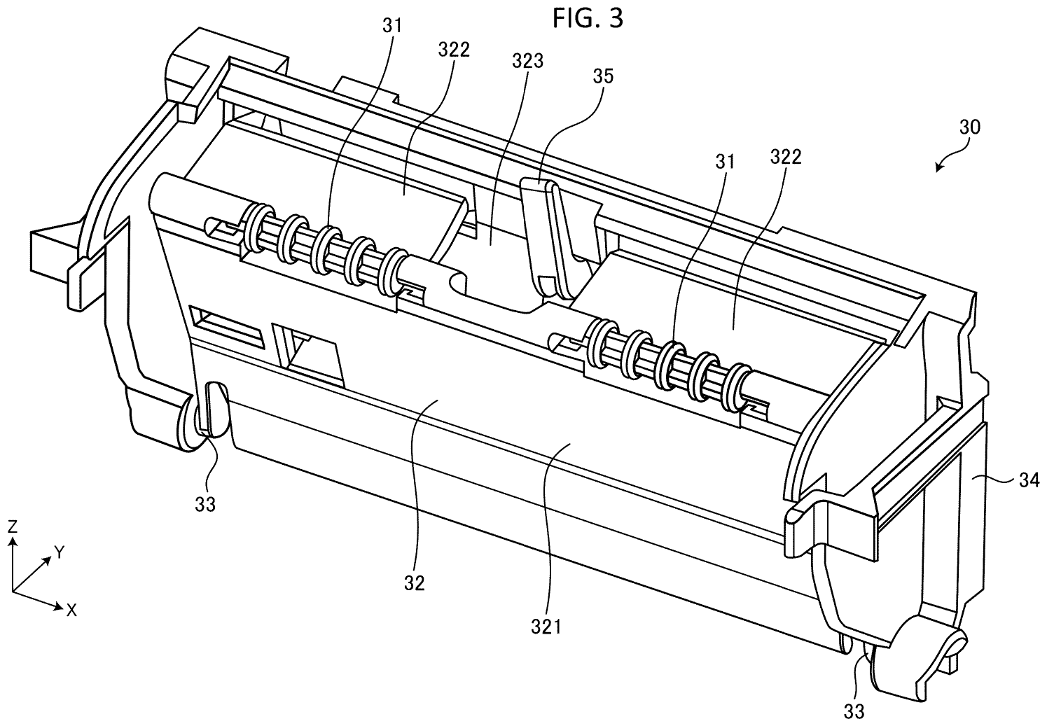

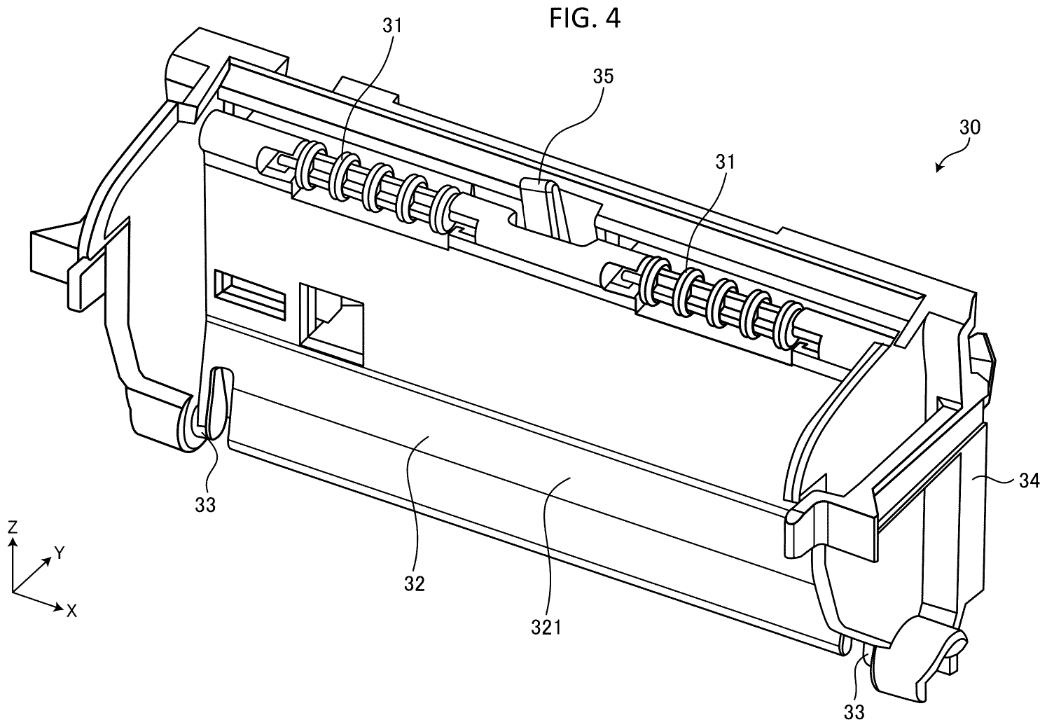

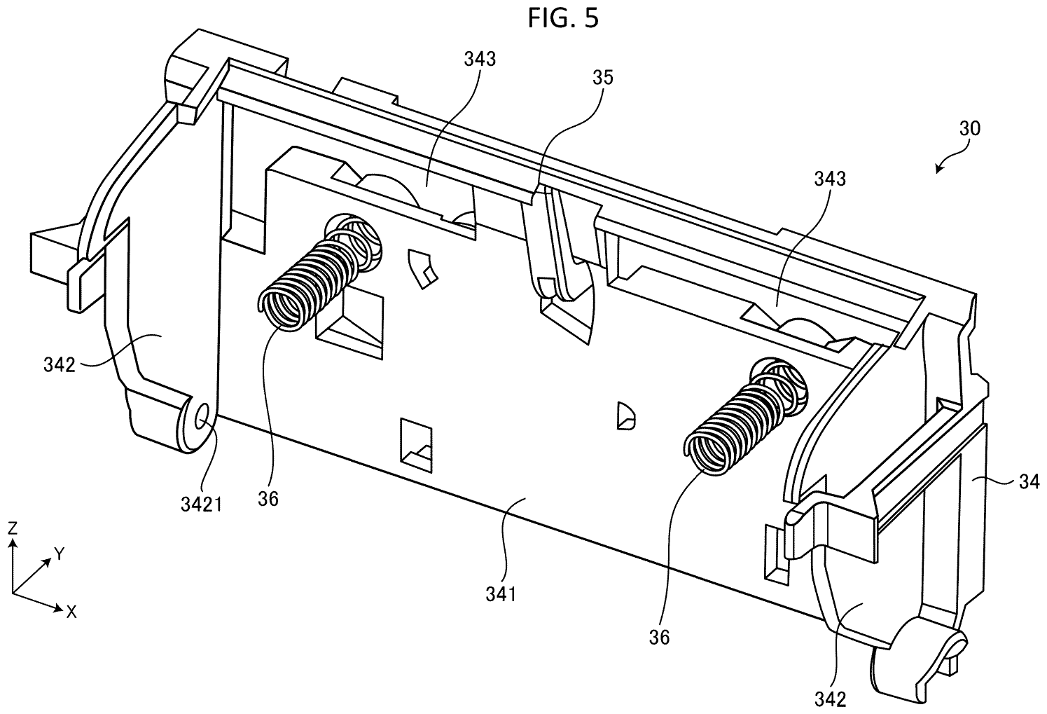

FIG. 3 to FIG. 5 are perspective views illustrating an example of the configuration of the damper unit 30. Here, FIGS. 3 to 5 are perspective views of the damper unit 30 viewed from the rear side of the printer 1, that is, from the side of the rolled sheet 22. FIG. 3 shows a state of the frame unit 32 that is rotated in a direction approaching the rolled sheet 22, and FIG. 4 shows a state of the frame unit 32 that is rotated in a direction away from the rolled sheet 22. FIG. 5 shows a state of the frame unit 32 removed from the damper unit 30.

The frame unit 32 has a substantially L-shaped cross section, and includes a first frame unit 321 disposed on a side facing the rolled sheet 22, and a second frame unit 322 provided above the first frame unit 321.

The first frame unit 321 is a plate-shaped member provided over the left-right direction of the printer 1. The first frame unit 321 includes frame rotation shafts 33 at the lower left and right end portions in the drawing. Further, the first frame unit 321 rotatably holds the rotation roller 31 at an upper corner portion in the drawing, which is a connection portion with the second frame unit 322.

The rotation rollers 31 are mounted in a pair at respective positions symmetrical with respect to the center position of the first frame unit 321 in the left-right direction, for example. Further, the rotation roller 31 has convexes and/or concaves on its surface, and is in contact with the thermal sheet 21 at a ring-shaped convex portion provided at a predetermined interval in the axial direction. The thermal sheet 21 drawn out from the rolled sheet 22 is conveyed in the conveyance direction B while being in contact with the rotation roller 31. At this time, by rotating the rotation roller 31, it is possible to reduce the sliding resistance when the thermal sheet 21 is conveyed.

The second frame unit 322 is a plate-like member extending from the upper corner portion of the first frame unit 321 toward the positive direction side of the Y-axis. The second frame unit 322 has a hole portion 323 at a center position in the left-right direction, and is separated in the left-right direction by the hole portion 323. The second frame unit 322 is inserted into a hole portion 343 provided in the base structure 34, which will be described later, as the frame unit 32 rotates in a direction away from the rolled sheet 22. A locking portion is provided at a distal end portion of the second frame unit 322 in the Y-axis positive direction so as to lock the second frame unit 322 so as not to be separated from the hole portion 343.

In addition, a distal end portion of an actuator 35 is disposed in the hole portion 323 of the second frame unit 322. The actuator 35 is disposed at a height in contact with the thermal sheet 21 conveyed via the rotation roller 31, and is biased upward in the drawing by an elastic member (not shown) such as a spring.

When the actuator 35 is in contact with the thermal sheet 21, it is pushed downward by the thermal sheet 21. The printer 1 includes a sensor (not shown) that senses the state of the actuator 35, and detects whether or not the thermal sheet 21 (or the rolled sheet 22) is out of sheet in accordance with the position of the actuator 35. Note that the sensor may be, for example, a microswitch that is a mechanical sensor, or may be a non-contact switch including an optical sensor.

The base structure 34 is a holding member for holding the frame unit 32 in the housing 10 of the printer 1. The base structure 34 includes a first base structure 341 facing the first frame unit 321, and a second base structure 342 located at the left and right end portions of the first frame unit 321.

The second base structure 342 extends from the left and right end portions of the first base structure 341 in the Y-axis negative direction. The second base structure 342 includes a bearing portion 3421 below which the frame rotation shaft 33 provided in the frame unit 32 (or the first frame unit 321) is rotatably held. That is, the frame unit 32, by the frame rotation shaft 33 is connected to the bearing portion 3421 of the second base structure 342, as shown in FIGS. 3 and 4, it is possible to rotate about the axis of the frame rotation shaft 33.

On the other hand, the first base structure 341 is disposed to face the first frame unit 321. The first base structure 341 has a hole portion 343 through which the above-described second frame unit 322 passes. The first base structure 341 has a hole portion through which the above-described actuator 35 passes.

Further, the first base structure 341 holds elastic members 36 for biasing the first frame unit 321 in the Y-axis negative direction in the drawing. Here, as illustrated in FIG. 5, the elastic members 36 are provided in a pair at respective positions symmetrical with respect to the center position of the first base structure 341 in the left-right direction, for example.

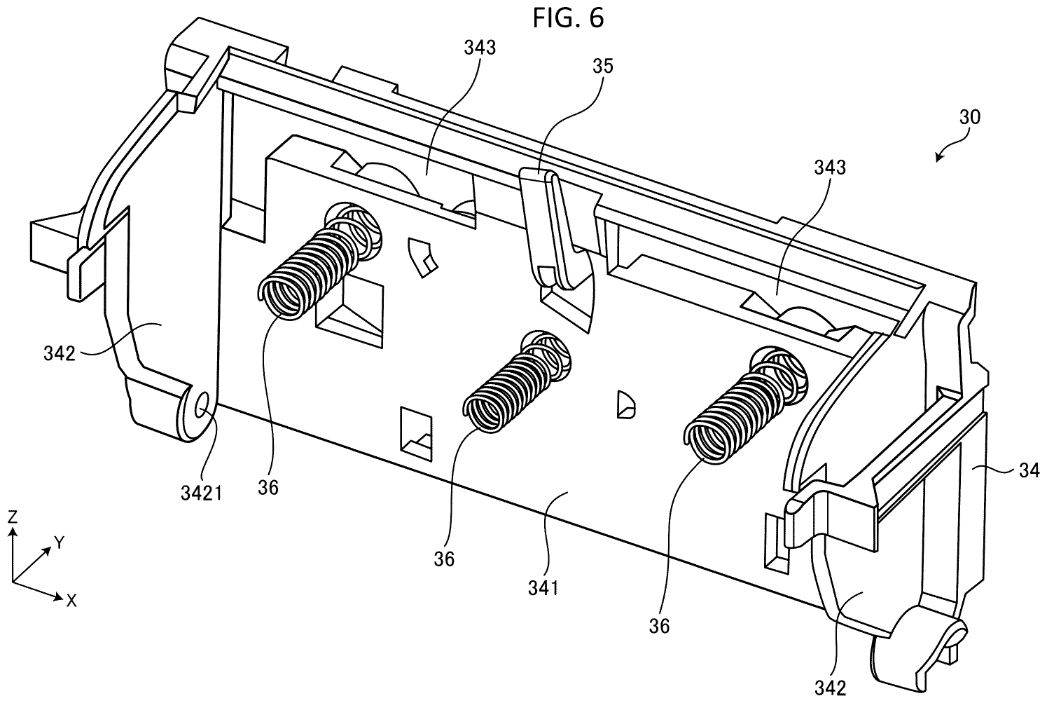

Incidentally, the arrangement position of each elastic member 36 is not limited to the example of FIG. 5. For example, as shown in FIG. 6, three elastic members 36 may be positioned symmetrically with respect to the center position of the first base structure 341 in the left-right direction.

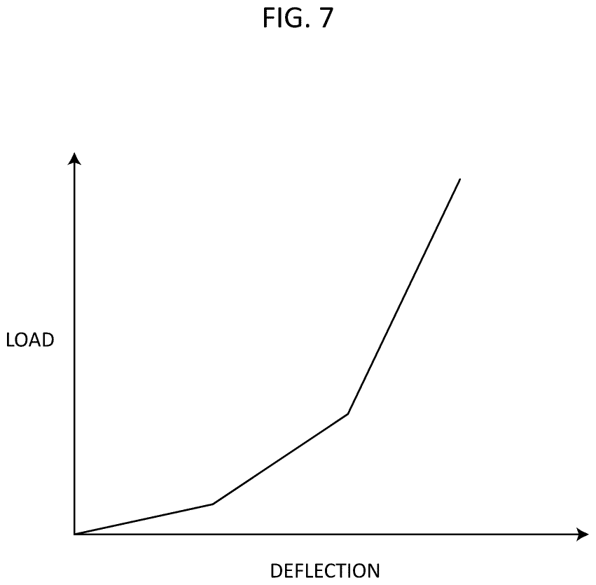

Here, each of the elastic members 36 is formed of a non-linear elastic member. Specifically, as shown in FIG. 7, the elastic member 36 has a characteristic that a deflection of the elastic member 36 with respect to a load (hereinafter, also referred to as a displacement amount of the elastic member 36) changes in a non-linear manner, that is, a spring constant. In such an elastic member 36, the spring constant increases with the displacement amount of the elastic member 36. FIG. 7 is a perspective view illustrating an example of the spring constant of the elastic member 36.

The elastic member 36 having such a specification is, for example, a compression coil spring having an unequal pitch. In this case, the elastic member 36 can be a compression coil spring having at least two different pitches. The elastic member 36 can also be a compression spring having a plurality of portions having different outer diameters, such as conical springs.

Although FIG. 7 shows a characteristic in which the displacement amount in three stages according to the load, the number of stages is not limited to this, and may be two or more stages. Further, the characteristics of the elastic member 36 may be such that the displacement amount with respect to the load changes in a curvilinear manner.

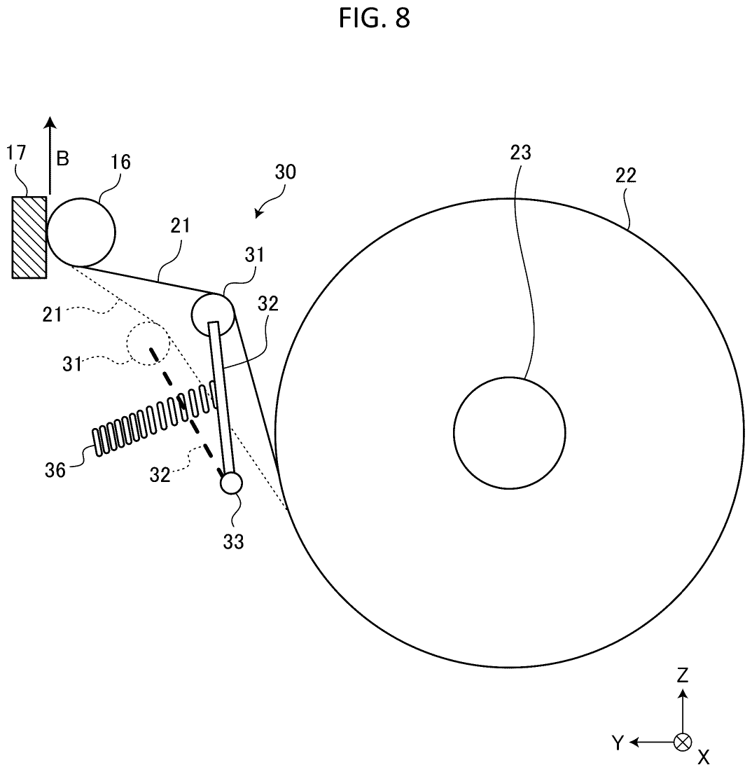

Next, the operation of the damper unit 30 will be described with reference to FIG. 8. Here, FIG. 8 is a diagram for explaining an operation example of the damper unit 30, and is an enlarged view of the periphery of the damper unit 30 shown in FIG. 2.

First, in a state in which no tension is applied to the thermal sheet 21, such as when the platen roller 16 is stopped, the frame unit 32 rotates in a direction approaching the rolled sheet 22 by the bias of the elastic member 36, so that the thermal sheet 21 is in a state indicated by a solid line in the drawing. Specifically, the thermal sheet 21 is pressed in the Y-axis negative direction by the rotation roller 31 attached to the front end of the frame unit 32, and is held in an upwardly deflected state (hereinafter, also referred to as a first state).

In this first state, when the conveyance in the conveyance direction B is started by the rotation of the platen roller 16, the frame unit 32 receives a pressing force in the Y-axis positive direction via the rotation roller 31 by the tension applied to the thermal sheet 21, and rotates in a direction away from the rolled sheet 22 as indicated by a broken line.

Further, with the movement of the frame unit 32, the pressing force is also applied to the elastic member 36, since the elastic member 36 is a non-linear elastic member as described above, the displacement amount is non-linear rather than linear. For example, when the elastic member 36 has the three-stage spring constant shown in FIG. 7, the spring constant changes three times in accordance with the magnitude of the pressing force. Thus, in the damper unit 30, the damper effect can be exerted against various loads ranging from a small pressing force to a large pressing force.

As described above, the printer 1 includes the storage unit 18 that stores the thermal sheet 21 (or the rolled sheet 22) wound in a roll shape, the platen roller 16 that pulls out and conveys the thermal sheet 21 from the storage unit 18, the thermal head 17 that prints on the thermal sheet 21 conveyed by the platen roller 16, and the damper unit 30 that is provided between the storage unit 18 and the platen roller 16 and that abuts on one surface side of the thermal sheet 21 conveyed by the platen roller 16 and biases the thermal sheet 21 with an elastic force, thereby reducing the tension applied to the thermal sheet 21 by the conveyance of the platen roller 16. The damper unit 30 includes the nonlinear elastic members 36, and biases the thermal sheet 21 by using the elastic force of the elastic members 36.

Thus, in the damper unit 30 of the printer 1, even when the tension applied to the thermal sheet 21 fluctuates due to the acceleration of transporting the thermal sheet 21, the state of the rolled sheet 22, or the like, the damper effect can be exerted against various tensions, so that the variation in tension applied to the thermal sheet 21 can be suitably reduced. Therefore, in the printer 1, the printing quality can be improved.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer comprising:
a storage unit in which a roll-shaped printing medium is stored;
a print head configured to print on the medium;
a first roller that is rotatable to draw out the medium from the storage unit while pressing the medium against the print head;
a damper disposed between the storage unit and the print head and against which the medium is pressed as a result of tension in the medium that is drawn out from the storage unit; and
an elastic body including one or more non-linear elastic members against which the damper is pressed when the medium is pressed against the damper.

2. The printer according to claim 1, wherein
the elastic members are compression coil springs having unequal pitches.

3. The printer according to claim 2, wherein
each of the coil springs includes a plurality of spring portions respectively having different pitches or diameters.

4. The printer according to claim 1, wherein
the elastic members are attached to a base structure and arranged along a longitudinal direction thereof.

5. The printer according to claim 4, wherein
the elastic members are arranged symmetrically with respect to a virtual center line on the base structure, the center line being perpendicular to the longitudinal direction.

6. The printer according to claim 5, wherein
one of the elastic members is on the center line.

7. The printer according to claim 1, wherein
the damper includes one or more second rollers against which the medium that is drawn out is pressed, and a pivot point about which the damper rotates to be pressed against the elastic body as the medium is drawn out.

8. The printer according to claim 1, further comprising:
a lower housing having an upper opening and in which the storage unit, the print head, the first roller, the damper, and the elastic body are stored; and
a cover that covers the upper opening.

9. The printer according to claim 8, further comprising:
a discharge port formed in a gap between the lower housing and the cover and through which the printed medium is discharged.

10. The printer according to claim 1, wherein
the medium is a thermal sheet.

11. A printer comprising:
a storage unit in which a roll-shaped printing medium is stored;
a print head configured to print on the medium;
a first roller that is rotatable to draw out the medium from the storage unit while pressing the medium against the print head;
a first plate that is rotatable about one side thereof and against which the medium is pressed as a result of tension in the medium that is drawn out from the storage unit, another side opposite to said one side contacting the medium between the storage unit and the print head;
a base structure that rotatably supports the first plate at said one side thereof; and
one or more non-linear elastic members sandwiched between the first plate and the base structure.

12. The printer according to claim 11, wherein
the elastic members are compression coil springs having unequal pitches.

13. The printer according to claim 12, wherein
each of the coil springs includes a plurality of spring portions respectively having different pitches or diameters.

14. The printer according to claim 11, wherein
the elastic members are arranged along a longitudinal direction of the base structure.

15. The printer according to claim 14, wherein
the elastic members are arranged symmetrically with respect to a virtual center line on the base structure, the center line being perpendicular to the longitudinal direction.

16. The printer according to claim 15, wherein
one of the elastic members is on the center line.

17. The printer according to claim 11, wherein
one or more second rollers are attached to said another side of the first plate and contact the medium.

18. The printer according to claim 11, further comprising:
a lower housing having an upper opening and in which the storage unit, the print head, the first roller, the first plate, the base structure, and the elastic members are stored; and
a cover that covers the upper opening.

19. The printer according to claim 18, further comprising:
a discharge port formed in a gap between the lower housing and the cover and through which the printed medium is discharged.

20. The printer according to claim 11, wherein
the medium is a thermal sheet.
